(19) United States
(12) Patent Application Publication
(10) Pub. No.: US 2020/0394534 A1
(43) Pub. Date: Dec. 17, 2020

(54) MULTI TASK ORIENTED RECOMMENDATION SYSTEM FOR BENCHMARK IMPROVEMENT

(71) Applicant: SAP SE, Walldorf (DE)

(72) Inventors: Kavitha Krishnan, Bangalore (IN); Naga Sai Narasimha Guru Charan Koduri, Bangalore (IN)

(21) Appl. No.: 16/442,004

(22) Filed: Jun. 14, 2019

(51) Int. Cl. G06N 5/04; G06F 11/34; G06N 3/04; G06N 20/00; G06F 17/15

(52) U.S. Cl. CPC G06N 5/04; G06F 11/3495; G06F 11/3428; G06N 20/00; G06F 17/15; G06N 3/04

(57) ABSTRACT

Methods and systems are used for improving benchmark key performance indicators (KPIs). As an example, a set of KPIs associated with a particular client is identified, each KPI of the identified set of KPIs associated with a plurality of KPI attributes. A set of particular KPI attributes associated with the identified set of KPIs associated with the particular client is identified. A recommendation assessment of the identified set of particular KPI attributes is performed using a trained recommendation reference model (RRM) to identify at least one operational recommendation for the particular client. A ranked set of the at least one operational recommendation is generated based on a ranking associated with each KPI of the at least one KPI of the identified set of KPIs. The ranked set of the at least one operational recommendation is provided to the particular client.

### SUMMARY

The present disclosure describes a multi task oriented recommendation system for improving client benchmark key performance indicators.

In an implementation, a computer-implemented method is used for improving client benchmark key performance indicators for a multi task oriented recommendation system. A set of key performance indicators (KPIs) associated with a particular client of a set of clients is identified, by a recommendation system, as an identified set of KPIs, each KPI of the identified set of KPIs associated with a plurality of KPI attributes used to determine a KPI score associated with each KPI. A set of particular KPI attributes associated with the identified set of KPIs associated with the particular client is identified, by the recommendation system, as an identified set of particular KPI attributes. A recommendation assessment of the identified set of particular KPI attributes is performed, by the recommendation system, using a trained recommendation reference model (RRM) to identify at least one operational recommendation for the particular client, the at least one operational recommendation associated with at least one KPI of the identified set of KPIs. A ranked set of the identified at least one operational recommendation is generated, by the recommendation system, based on a ranking associated with each KPI of the at least one KPI of the identified set of KPIs. The ranked set of the identified at least one operational recommendation is provided, by the recommendation system, to the particular client. The at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client. A RRM is trained to generate the trained RRM using a machine learning algorithm, a set of reference KPI attributes, a set of reference KPIs associated with at least one client, a set of reference operational recommendations, where the set of reference KPIs includes at least the identified set of KPIs, and where the set of reference operational recommendations includes at least the at least one operational recommendation. Training the RRM further comprises using a loss function. The loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs. The machine learning algorithm comprises at least one of a supervised learning algorithm using a deep neural network (DNN). The DNN comprises at least one of a convolution neural network or a long short-term memory (LSTM).

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, by training a RRM to generate a trained RRM using at least a machine learning algorithm and a set of reference KPIs and using the trained RRM, determining at least one operation recommendation of the set of reference operational recommendations for each reference KPI of the set of reference KPIs may be done at the same time instead of generating and training a RRM for each reference KPI over different times. Second, by generating a ranked set of the at least one operational recommendation in priority order based on a ranking associated with each KPI of the at least one KPI of the identified set of KPIs and providing the ranked set of the at least one operational recommendation to a particular client, the particular client may utilize the prioritized set of operational recommendations to take corrective actions to improve their KPIs performance.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example distributed computing system (DCS) for improving client benchmark key performance indicators, according to an implementation of the present disclosure.

FIG. 2 is a flowchart illustrating an example of a computer-implemented method for improving client benchmark key performance indicators, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes a multi task oriented recommendation system for improving client benchmark key performance indicators, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

For the purposes of this disclosure, a key performance indicator (KPI) is a quantifiable measure that may be used to evaluate the success of an organization in meeting objectives for performance. A KPI may be associated with a plurality of KPI attributes that may be used to determine a KPI score associated with the KPI. A standard set of KPIs may be defined and utilized by multiple organizations to allow each organization to evaluate their performance against these standard KPIs. Gathering and maintaining performance data for the multiple organizations may also allow each organization to benchmark their performance against these standard KPIs. After benchmarking their performance, an organization may identify one or more KPIs that are underperforming against these standard KPIs, such as, for example, the identified one or more KPIs may be below a best in class of the corresponding one or more KPIs across the multiple organizations and or an average of the corresponding one or more KPIs across the multiple organizations. An organization may have a pre-defined set of recommendations that may be best practices recommendations. Typically, when one or more KPIs have been identified as underperforming, an organization may perform a manual process to identify one or more recommendations from the pre-defined best practices set of recommendations that may be able to improve the one or more underperforming KPIs. The pre-defined best practices set of recommendations may include a large number of recommendations, such as, for example, tens, hundreds, or more recommendations, which may make it difficult to determine which of the best practices recommendations to select. Determining the contribution of each of the plurality of KPI attributes used to determine the KPI score associated with each of the one or more underperforming KPIs may make it even more difficult to determine which of the best practices recommendations to select. In addition, there may be no ranking of the identified one or more recommendations and/or no importance or relevance to the underperforming KPIs associated with each of the one or more recommendations, which may result in the organization being unable to determine what effect each of these recommendations may have on improving the one or more underperforming KPIs, the organization implementing only some of these recommendations having the least effect, or the organization implementing all of these recommendations when some of them only have a minimal effect.

In contrast to the typical manual process of determining recommendations, a multi task oriented recommendation system (also referred herein as a recommendation system) for improving client benchmark key performance indicators is disclosed herein. A recommendation reference model (RRM) of the recommendation system may be trained on a set of reference KPI attributes, a set of reference KPIs associated with at least one client, and a set of reference operational recommendations. The recommendation system may identify a set of KPIs associated with a particular client of a set of clients as an identified set of KPIs, each KPI of the identified set of KPIs may be associated with a plurality of KPI attributes used to determine a KPI score associated with each KPI. The recommendation system may identify a set of particular KPI attributes associated with the identified set of KPIs associated with the particular client as an identified set of particular KPI attributes. The recommendation system may perform a recommendation assessment of the identified set of particular KPI attributes using the trained RRM to identify at least one operational recommendation for the particular client, the at least one operational recommendation may be associated with at least one KPI of the identified set of KPIs. The recommendation system may generate a ranked set of the at least one operational recommendation based on a ranking associated with each KPI of the at least one KPI of the identified set of KPIs. The recommendation system may provide the ranked set of the at least one operational recommendation to the particular client.

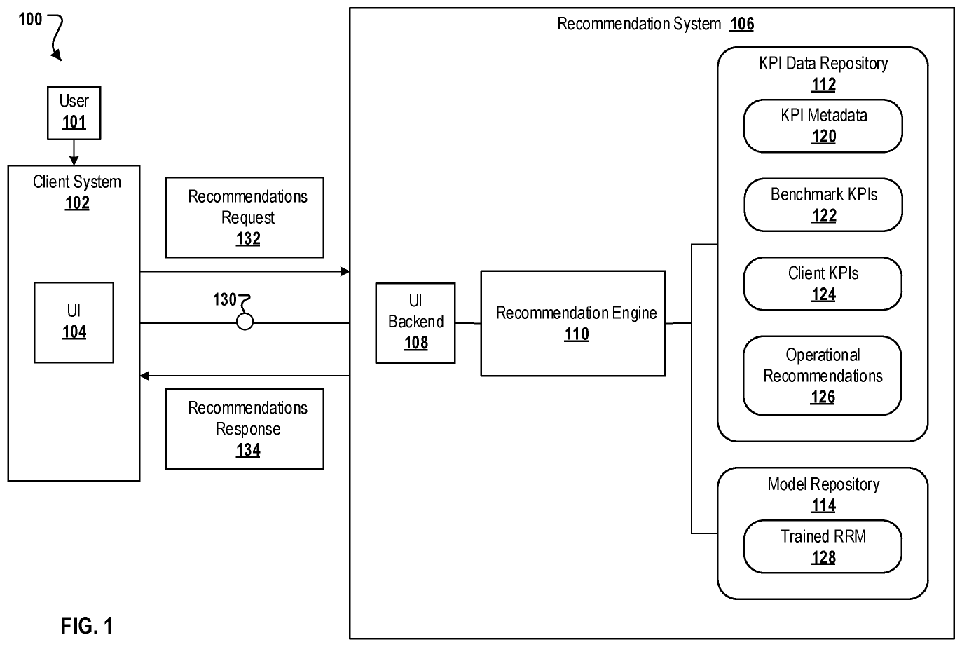

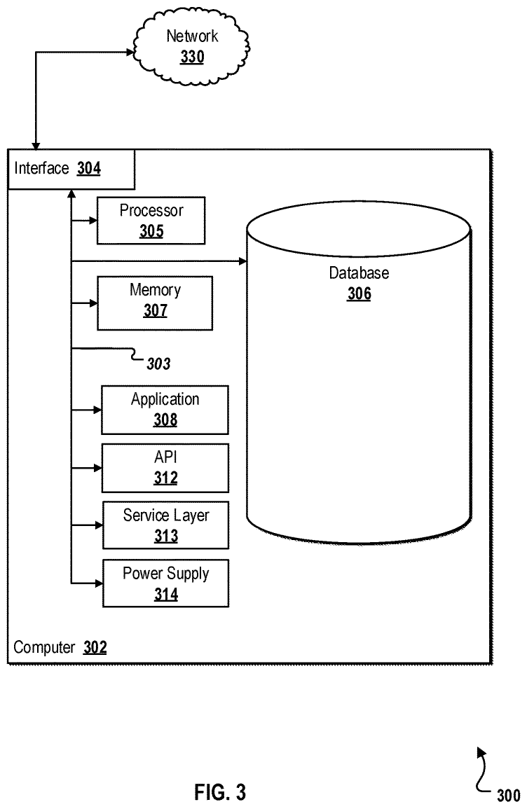

FIG. 1 is a block diagram illustrating an example distributed computing system (DCS) 100 for improving client benchmark key performance indicators, according to an implementation of the present disclosure. At a high level, the illustrated DCS 100 includes or is made up of one or more communicably coupled computers or other components (see FIG. 3) that communicate across a network 130 (e.g., operating within a cloud-computing-based environment). The illustrated DCS 100 includes a user 101 (also referred herein as a client or a customer), a client system 102, a user interface (UI) 104, a recommendation system 106, a UI backend 108, a recommendation engine 110, a key performance indicator (KPI) data repository 112, and a model repository 114. Although the detailed description is focused on benchmark key performance indicators improvement functionality, other functionality is envisioned to be covered by the described subject matter. Discussion of benchmark key performance indicators improvement functionality is not intended to limit the detailed description to only data state transfer functionality and/or to limit the detailed description in any way.

The client system 102 may be any computing device operable to connect to and/or communicate with at least the recommendation system 106 (or components interfacing with any of these—whether or not illustrated). In general, the client system 102 comprises an electronic computing device operable to receive, transmit, process, and store any appropriate data associated with the DCS 100. There may be any number of client systems 102 associated with, or external to, the DCS 100.

The UI 104 is a client-side interface that may be installed on one or more client systems 102. The UI 104 may comprise a trusted secure interface between the UI 104 and the UI backend 108 of the recommendation system 106. The UI 104 may provide a minimal set of functionality needed to support authentication and communication with the UI backend 108. In particular, the minimal set of functionality provided by the UI 104 may include, for example, user authentication at the UI backend 108, management of security data, such as, open authorization (OAuth) refresh and access tokens provided by an OAuth server (not illustrated in FIG. 1), exchange of recommendations request data and recommendations response data. The UI 104 may provide security data in a recommendations request 132. The security data may include an OAuth access token which the UI backend 108 may utilize for authenticating the UI 104.

The recommendation system 106 may be any computing device operable to connect to and/or communicate with at least the client system 102, (or components interfacing with any of these—whether or not illustrated). As illustrated, the recommendation system 106 connects or interfaces to a single client system 102. In other instances, the recommendation system 106 may connect to a plurality of client systems 102, where appropriate. In general, the recommendation system 106 comprises an electronic computing device operable to receive, transmit, process, and store any appropriate data associated with the DCS 100.

The UI backend 108 is a recommendation system-side interface that may be installed as part of the recommendation system 106. The UI backend 108 may comprise a trusted secure interface between the UI 104 and the UI backend 108 of the recommendation system 106. The UI backend 108 may provide a minimal set of functionality needed to support authentication and communication with the UI backend 108. In particular, the minimal set of functionality provided by the UI backend 108 may include, for example, user authentication at the UI backend 108, management of security data, such as, open authorization (OAuth) refresh and access tokens provided by an OAuth server (not illustrated in FIG. 1), exchange of recommendations request data and recommendations response data. The UI backend 108 may receive security data in a recommendations request 132. The security data may include an OAuth access token which the UI backend 108 may utilize for authenticating the UI 104.

A KPI may be a metric that may be used to evaluate the success of an organization in meeting objectives for performance. A KPI may be associated with a plurality of KPI attributes that may be used to determine a KPI score associated with the KPI. A standard set of KPIs may be defined and utilized by multiple organizations to allow each organization to evaluate their performance against these standard KPIs, as previously described. For example, a KPI may comprise a client performance score, where the higher the value, the better the client is performing. As another example, a KPI may comprise a percentage of spend on a particular network, where the higher the percentage of spend of the client routed through the particular network, the more benefits accrue to the client.

Each KPI of a set of KPIs, such as, for example, the standard set of KPIs, may be associated with KPI metadata. The KPI metadata associated with each KPI of the set of KPIs may include at least one of a KPI name associated with each KPI, a solution associated with each KPI, a ranking of each KPI, an interpretation of a value of each KPI, and a set of KPI attributes associated with each KPI. The KPI name associated with each KPI may be unique to each particular KPI, such that, the KPI name associated with each particular KPI is different than the KPI name associated with any other KPI. The solution associated with each KPI may comprise at least one of a sourcing solution, a marketing solution, a sales solution, a client service solution, a customer service solution, or another type of solution. The ranking of each KPI may indicate how important each particular KPI is in relation to each of the other KPIs of the set of KPIs. The interpretation of a value of each KPI may indicate whether a change in the value of the KPI from a previous value is a positive change (an improvement) or a negative change (a decline). For example, an increase in the value of a KPI from the previous KPI value may indicate a positive change (an improvement), such as, for example sales have increased. As another example, an increase in the value of a KPI from the previous KPI value may indicate a negative change (worsening change), such as, for example error rates and/or failure rates have increased.

The set of KPI attributes associated with each KPI may comprise at least one of a set of input attributes, an output attribute, a preference attribute, an industry maturity attribute, an industry attribute, and a region attribute. Each input attribute of the set of input attributes may comprise an attribute name associated with each input attribute. An output attribute may comprise an attribute name associated with the output attribute. A preference attribute may comprise the attribute name of a particular input attribute which has a higher preference than the other input attributes. An industry maturity attribute may be a value indicating how long a particular organization has been competing compared to similarly sized companies. The industry maturity attribute may be used to avoid comparing a new small organization against a very large established organization that may have been in operation for a much longer period of time. An industry attribute may indicate the industry that the organization associated with this KPI belongs to. The industry attribute may allow organizations to be compared against other organizations in the same industry. A region attribute may indicate the operating region associated with the organization and this particular KPI. The region attribute may allow organizations to be compared against other organizations operating within the same region.

The KPI metadata 120 may comprise the KPI metadata associated with each KPI of the set of KPIs and may be stored at the KPI data repository 112 of the recommendation system 106. An example of KPI metadata 120 is shown in Example KPI metadata Table 1.

TABLE 1
Example KPI Metadata

| | | | | KPI |
|---|---|---|---|---|
| KPI Name | Solution | Ranking | Interpretation | Attributes |
| KPI 1 | Sourcing | 3 | Increase is Good | Attr 1, Attr 2, |
| | | | | Attr 3, Attr 4 |
| KPI 2 | Sourcing | 1 | Decrease is Good | Attr 2, Attr 4, Attr 6 |
| KPI 3 | Sourcing | 2 | Increase is Good | Attr 2, Attr 6 |
| KPI 4 | Sourcing | 4 | Increase is Good | Attr 1, Attr 5 |

Benchmark KPIs 122 may be stored at the KPI data repository 112. The benchmark KPIs 122 may include at least one of a KPI name associated with each KPI of the set of KPIs, a best in class value, an average value, an industry best in class value, an industry average value, a region best in class value, a region average value, or one or more other classification values. The best in class value, the average value, the industry best in class value, the industry average value, the region best in class value, the region average value, or the one or more other classification values may be calculated across all of the clients represented in the KPI metadata 120 for each KPI. An example of benchmark KPIs 122 is shown in Example benchmark KPIs Table 2.

TABLE 2
Example benchmark KPIs

| KPI | Best | | Industry | Industry | Region | Region |
|---|---|---|---|---|---|---|
| Name | in Class | Average | Best in Class | Average | Best in Class | Average |
| KPI 1 | 10 | 8 | 9 | 7 | 8 | 6 |
| KPI 2 | 9 | 12 | 8 | 11 | 7 | 10 |
| KPI 3 | 13 | 7 | 12 | 6 | 11 | 5 |
| KPI 4 | 9 | 6 | 9 | 6 | 9 | 6 |

Clients KPIs 124 may be stored at the KPI data repository 112. Each client KPIs of the client KPIs 124 may include at least one of a client name associated with each client KPIs, a KPI name associated with each KPI of the set of KPIs associated with each client KPIs, or a client value associated with each KPI of the set of KPIs associated with each client KPIs. The client value associated with each KPI of the set of KPIs associated with each client KPIs may be calculated for each client represented in the KPI metadata 120. An example of the clients KPIs 124 is shown in Example clients KPIs Table 3.

TABLE 3
Example clients KPIs

| Client Name | KPI Name | Client Value |
|---|---|---|
| Client 1 | KPI 1 | 2 |
| Client 1 | KPI 2 | 7 |
| Client 1 | KPI 3 | 6 |
| Client 1 | KPI 4 | 7 |

Operational recommendations 126 may be stored at the KPI data repository 112. The operational recommendations 126 may include a predefined set of operational recommendations for each KPI, which have been identified to improve an organization's performance for each particular KPI as best practices. The predefined set of operational recommendations may comprise, for example, at least one of a recommendation 1 (R 1) to review opportunities to enable more spend and transactions that are catalog based to eliminate spend leakage from maverick buying, a recommendation 2 (R 2) to consider enabling more suppliers and transactions over a particular network to take advantage of an existing platform, which may help increase the percentage of transactions that are electronic, a recommendation 3 (R 3) to review bottlenecks in non-catalog requisition cycle time and determine opportunities to migrate non-catalog orders to catalog based orders, which may result in a shorter requisition to order cycle time, a recommendation n (R n) to review opportunities to conduct regular spend reviews with internal stakeholders to influence more sourcing spend under management, or another recommendation. An example of operational recommendations 126 is shown in Example operational recommendations Table 4.

TABLE 4
Example operational recommendations

| Recommendation | Solution |
|---|---|
| R 1 | Sourcing |
| R 2 | Sourcing |
| . . . | Sourcing |
| R n | Sourcing |

The recommendation engine 110 comprises a Machine Learning model recommendation reference model (RRM) which is trained using a multi-task classification approach on at least one of a set of reference KPI attributes, a set of reference KPIs associated with at least one client, or a set of reference operational recommendations. The set of reference KPI attributes may include at least the set of KPI attributes associated with each KPI of the set of KPIs in the KPI metadata 120 stored at the KPI data repository 112. The set of reference KPIs may include at least the set of KPIs in the KPI metadata 120 stored at the KPI data repository 112. The set of reference operational recommendations may include at least the set of operational recommendations 126 stored at KPI data repository 112. The recommendation engine 110 may store the trained RRM 128 at model repository 114.

Under various tasks the recommendation engine performs, one task is to predict, based on the set of reference KPI attributes, whether the performance of each KPI of the set of reference KPIs is doing well or doing poorly. A second task is to train the RRM to determine at least one operation recommendation of the set of reference operational recommendations to recommend to improve the performance of each KPI of the set of reference KPIs that is doing poorly. The machine learning algorithm may perform both tasks at the same time in the multi task classification approach.

Predicting the performance of each reference KPI of the set of reference KPIs can be treated as a binary classification problem. The model will try to predict whether each reference KPI of the set of reference KPIs is performing poorly or performing well, for example, when the KPI performance indicator has a value of 0 indicating that the reference KPI is performing poorly, and for example, when the KPI performance indicator has a value of 1 indicating that the reference KPI is performing well. The loss function may be a binary logistic loss function because there are only two classes whether the KPI performance is doing poorly or doing well.

Determining at least one operational recommendation of the set of reference operational recommendations to recommend is the second task which can be treated as a multi-label classification problem. Each operational recommendation of the set of reference operational recommendations is a single class of the multi-label problem. The set of reference operational recommendations may have “n” operational recommendations in the set, the multi-label problem may have “n” classes. The set of reference operational recommendations may be generic across all the KPIs of the set of reference KPIs. There are multiple ways to solve a multi-label problem including a binary relevance method, where the multi-label problem is transformed into binary classification problems. The complete loss function that may be used to train the recommendation engine for both the tasks may comprise the loss function L:

L=Σᵢ₌₀^{no of KPI's}L(ƒi(X),yi)))

Each individual loss function Li may be a logistic loss for each reference KPIi of the set of reference KPIs, where the set of reference KPIs has “n” reference KPIs in the set. In the loss function L, X may be equal to the union of all the input attributes of all the reference KPIs of the set of reference KPIs for a particular solution, Y may include at least the set of [y₁, y₂, y₃, . . . yᵢ], where yᵢ is the output of the jth reference KPI, KPIj, of the set of reference KPIs. In Y, each row may represent one reference KPI of the set of “n” reference KPIs, y_{(i,0)} may represent a KPI performance indicator, and y_{(i, 1 . . . j)} may represent the set of reference operational recommendations. The KPI performance indicator may have a value of 0 indicating that the KPI is performing poorly or may have a value of 1 indicating that the KPI is performing well. For both tasks, the loss functions can be binary loss functions, the summation of the binary losses of both the tasks, where one task can be a binary classification problem and the second task can be a multi-label problem with binary relevance, can be calculated and the weights of the neural network can be updated based on the calculation. The machine learning algorithm may train the RRM using the one training loss function to generate the trained RRM 128.

The machine learning algorithm may further comprise at least one of a supervised learning algorithm using a deep neural network (DNN). The DNN may comprise at least one of a convolution neural network or a long short-term memory (LSTM), which is an artificial recurrent neural network (RNN), or another type of deep neural network. The RRM may comprise the DNN and the one training loss function may be utilized to train the DNN and generate a trained DNN. The one training loss function may be used to update the weights for the DNN. The trained RRM 128 may further comprise the trained DNN. By training the DNN with the above approach, determining at least one operation recommendation of the set of reference operational recommendation for each reference KPI of the set of reference KPIs may be done at the same time instead of generating and training a RRM for each reference KPI over different times.

During run-time, the recommendation engine 110 may identify a set of KPIs associated with a particular client of a set of clients as an identified set of KPIs based on the client KPIs 124 stored at the KPI data repository 112 The identified set of KPIs associated with the particular client may comprise the set of KPIs associated with the client KPIs having the client name that matches the particular client in the client KPIs 124. Each KPI of the identified set of KPIs may be associated with a plurality of KPI attributes used to determine a KPI score associated with each KPI. In the example clients KPIs Table 3, previously described, the identified set of KPIs associated with the the particular client may comprise the set of KPIs including KPI 1, KPI 2, KP 3, and KPI 4 associated with client 1.

The recommendation engine 110 may identify a set of particular KPI attributes associated with the identified set of KPIs associated with the particular client as an identified set of particular KPI attributes based on the KPI metadata 120 stored at the KPI data repository 112. The identified set of particular KPI attributes may comprise the set of KPI attributes associated with each KPI of the set of KPIs in the KPI metadata 120 that matches each KPI of the identified set of KPIs. In the example KPI metadata Table 1, previously described, the identified set of particular KPI attributes associated with the identified set of KPIs associated with the particular client including KPI 1, KPI 2, KP 3, and KPI 4 associated with client 1 may comprise the set of KPI attributes Attr 1, Attr 2, Attr 3, Attr 4, Attr 5, and Attr 6.

The recommendation engine 110 may perform a recommendation assessment of the identified set of particular KPI attributes using the trained RRM 128 to identify at least one operational recommendation for the particular client, the at least one operational recommendation may be associated with at least one KPI of the identified set of KPIs. When the recommendation engine 110 performs the recommendation assessment using the example identified set of particular KPI attributes comprising the set of KPI attributes Attr 1, Attr 2, Attr 3, Attr 4, Attr 5, and Attr 6, previously described, as input parameters X to the trained RRM 128, the example set of the at least one operational recommendation as the output Y is shown below in Table 5. Table 5 may be used to interpret the results of the recommendation assessment.

TABLE 5

| KPI | KPI | Recommend | Recommend | Recommend |
|---|---|---|---|---|
| Name | Performance | 1 | 2 | n |
| KPI 1 | Doing Poorly(0) | No(0) | Yes(1) R 2 | Yes(1) R n |
| KPI 2 | Doing Well(1) | No(0) | No(0) | No(0) |
| KPI 3 | Doing Poorly(0) | No(0) | No(0) | Yes(1) R n |
| KPI 4 | Doing Well(1) | No(0) | No(0) | No(0) |

The trained RRM 128 determined that only KPI 1 and KPI 2 were performing poorly against the benchmark set of KPIs. As such, no recommendations were made for KPI 2 and KPI 4, which were performing well against the benchmark set of KPIs. The input parameters X are Attr 1, Attr 2, Attr 3, Attr 4, Attr 5, and Attr 6, and the output Y of the trained RRM 128 shown as a set of vectors is:

Y=[[0, 0, 1, 0], KPI 1 is doing poorly and R 2 and R n are recommended

[1, 0, 0, 0], KPI 2 is doing well

[0, 0, 0, 1], KPI 3 is doing poorly and R n is recommended

[0, 1, 0, 0]] KPI 4 is doing well

The recommendation engine 110 may generate a ranked set of the at least one operational recommendation based on a ranking associated with each KPI of the at least one KPI of the identified set of KPIs and the KPI metadata 120 stored at the KPI data repository 112. In the example KPI metadata 120 in example KPI metadata Table 1, previously described, the ranked set of the at least one operational recommendation may comprise the operational recommendation R n followed by the operational recommendations R 2 and R n because KPI 3 has a ranking value of 2 which is higher than the ranking value of KPI 1 which has a ranking value of 1.

The recommendation engine 110 may provide the ranked set of the at least one operational recommendation to the particular client. In the example, the ranked set of the at least one operational recommendation may comprise the operational recommendation R n followed by the operational recommendations R 2 and R n, which may be provided to client 1.

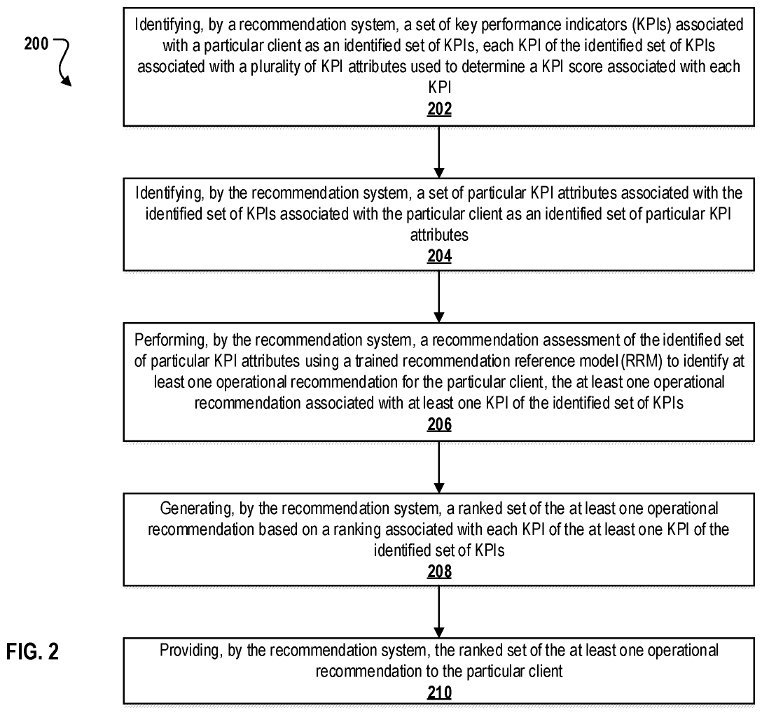

FIG. 2 is a flowchart illustrating an example of a computer-implemented method 200 for improving client benchmark key performance indicators, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 202, a set of key performance indicators (KPIs) associated with a particular client of a set of clients is identified, by a recommendation system, as an identified set of KPIs, each KPI of the identified set of KPIs associated with a plurality of KPI attributes used to determine a KPI score associated with each KPI. In some implementations, a RRM is trained to generate the trained RRM using a machine learning algorithm, a set of reference KPI attributes, a set of reference KPIs associated with at least one client, a set of reference operational recommendations, where the set of reference KPIs includes at least the identified set of KPIs, and where the set of reference operational recommendations includes at least the at least one operational recommendation. From 202, method 200 proceeds to 204.

At 204, a set of particular KPI attributes associated with the identified set of KPIs associated with the particular client is identified, by the recommendation system, as an identified set of particular KPI attributes. In some implementations, training the RRM further comprises using a loss function. In some implementations, the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs. In some implementations, the machine learning algorithm comprises at least one of a supervised learning algorithm using a deep neural network (DNN). In some implementations, the DNN comprises at least one of a convolution neural network or a long short-term memory (LSTM). From 204, method 200 proceeds to 206.

At 206, a recommendation assessment of the identified set of particular KPI attributes is performed, by the recommendation system, using a trained recommendation reference model (RRM) to identify at least one operational recommendation for the particular client, the at least one operational recommendation associated with at least one KPI of the identified set of KPIs. In some implementations, the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client. From 206, method 200 proceeds to 208.

At 208, a ranked set of the at least one operational recommendation is generated, by the recommendation system, based on a ranking associated with each KPI of the at least one KPI of the identified set of KPIs. From 208, method 200 proceeds to 210.

At 210, the ranked set of the at least one operational recommendation is provided, by the recommendation system, to the particular client. After 210, method 200 stops.

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, System 300 includes a Computer 302 and a Network 330.

The illustrated Computer 302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 302 can include an input device, such as a keypad, keyboard, or touch screen, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as, for example, a client, network component, a server, or a database or another persistency, or a combination of roles for performing the subject matter described in the present disclosure. The illustrated Computer 302 is communicably coupled with a Network 330. In some implementations, one or more components of the Computer 302 can be configured to operate within an environment, or a combination of environments, including cloud-computing, local, or global.

At a high level, the Computer 302 is an electronic computing device operable to receive, transmit, process, store, or manage data and information associated with the described subject matter. According to some implementations, the Computer 302 can also include or be communicably coupled with a server, such as an application server, e-mail server, web server, caching server, or streaming data server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory or conventional database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

Described implementations of the subject matter can include one or more features, alone or in combination.

For example, in a first implementation, computer-implemented method, comprising: identifying, by a recommendation system, a set of key performance indicators (KPIs) associated with a particular client of a set of clients as an identified set of KPIs, each KPI of the identified set of KPIs associated with a plurality of KPI attributes used to determine a KPI score associated with each KPI; identifying, by the recommendation system, a set of particular KPI attributes associated with the identified set of KPIs associated with the particular client as an identified set of particular KPI attributes; performing, by the recommendation system, a recommendation assessment of the identified set of particular KPI attributes using a trained recommendation reference model (RRM) to identify at least one operational recommendation for the particular client as the identified at least one operational recommendation, the identified at least one operational recommendation associated with at least one KPI of the identified set of KPIs; generating, by the recommendation system, a ranked set of the identified at least one operational recommendation based on a ranking associated with each KPI of the at least one KPI of the identified set of KPIs; and providing, by the recommendation system, the ranked set of the identified at least one operational recommendation to the particular client.

The foregoing and other described implementations can each, optionally, include one or more of the following features:

A first feature, combinable with any of the following features, wherein the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client.

A second feature, combinable with any of the previous or following features, further comprising: training a RRM to generate the trained RRM using a machine learning algorithm, a set of reference KPI attributes, a set of reference KPIs associated with at least one client, and a set of reference operational recommendations, wherein the set of reference KPIs includes at least the identified set of KPIs, and wherein the set of reference operational recommendations includes at least the at least one operational recommendation.

A third feature, combinable with any of the previous or following features, wherein training the RRM further comprises using a loss function.

A fourth feature, combinable with any of the previous or following features, wherein the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs.

A fifth feature, combinable with any of the previous or following features, wherein the machine learning algorithm comprises at least one of a supervised learning algorithm using a deep neural network (DNN).

A sixth feature, combinable with any of the previous or following features, wherein the DNN comprises at least one of a convolution neural network or a long short-term memory (LSTM).

In a second implementation, a non-transitory, computer-readable medium storing one or more instructions executable by a computer system to perform operations comprising: identifying, by a recommendation system, a set of key performance indicators (KPIs) associated with a particular client of a set of clients as an identified set of KPIs, each KPI of the identified set of KPIs associated with a plurality of KPI attributes used to determine a KPI score associated with each KPI; identifying, by the recommendation system, a set of particular KPI attributes associated with the identified set of KPIs associated with the particular client as an identified set of particular KPI attributes; performing, by the recommendation system, a recommendation assessment of the identified set of particular KPI attributes using a trained recommendation reference model (RRM) to identify at least one operational recommendation for the particular client as the identified at least one operational recommendation, the identified at least one operational recommendation associated with at least one KPI of the identified set of KPIs; generating, by the recommendation system, a ranked set of the identified at least one operational recommendation based on a ranking associated with each KPI of the at least one KPI of the identified set of KPIs; and providing, by the recommendation system, the ranked set of the identified at least one operational recommendation to the particular client.

The foregoing and other described implementations can each, optionally, include one or more of the following features:

A first feature, combinable with any of the following features, wherein the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client.

A second feature, combinable with any of the previous or following features, further comprising: training a RRM to generate the trained RRM using a machine learning algorithm, a set of reference KPI attributes, a set of reference KPIs associated with at least one client, and a set of reference operational recommendations, wherein the set of reference KPIs includes at least the identified set of KPIs, and wherein the set of reference operational recommendations includes at least the at least one operational recommendation.

A third feature, combinable with any of the previous or following features, wherein training the RRM further comprises using a loss function.

A fourth feature, combinable with any of the previous or following features, wherein the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs.

A fifth feature, combinable with any of the previous or following features, wherein the machine learning algorithm comprises at least one of a supervised learning algorithm using a deep neural network (DNN).

A sixth feature, combinable with any of the previous or following features, wherein the DNN comprises at least one of a convolution neural network or a long short-term memory (LSTM).

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: identifying, by a recommendation system, a set of key performance indicators (KPIs) associated with a particular client of a set of clients as an identified set of KPIs, each KPI of the identified set of KPIs associated with a plurality of KPI attributes used to determine a KPI score associated with each KPI; identifying, by the recommendation system, a set of particular KPI attributes associated with the identified set of KPIs associated with the particular client as an identified set of particular KPI attributes; performing, by the recommendation system, a recommendation assessment of the identified set of particular KPI attributes using a trained recommendation reference model (RRM) to identify at least one operational recommendation for the particular client as the identified at least one operational recommendation, the identified at least one operational recommendation associated with at least one KPI of the identified set of KPIs; generating, by the recommendation system, a ranked set of the identified at least one operational recommendation based on a ranking associated with each KPI of the at least one KPI of the identified set of KPIs; and providing, by the recommendation system, the ranked set of the identified at least one operational recommendation to the particular client.

The foregoing and other described implementations can each, optionally, include one or more of the following features:

A first feature, combinable with any of the following features, wherein the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client.

A second feature, combinable with any of the previous or following features, further comprising: training a RRM to generate the trained RRM using a machine learning algorithm, a set of reference KPI attributes, a set of reference KPIs associated with at least one client, and a set of reference operational recommendations, wherein the set of reference KPIs includes at least the identified set of KPIs, and wherein the set of reference operational recommendations includes at least the at least one operational recommendation.

A third feature, combinable with any of the previous or following features, wherein training the RRM further comprises using a loss function.

A fourth feature, combinable with any of the previous or following features, wherein the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs.

A fifth feature, combinable with any of the previous or following features, wherein the machine learning algorithm comprises at least one of a supervised learning algorithm using a deep neural network (DNN).

A sixth feature, combinable with any of the previous or following features, wherein the DNN comprises at least one of a convolution neural network or a long short-term memory (LSTM).

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
identifying, by a recommendation system, a set of key performance indicators (KPIs) associated with a particular client of a set of clients as an identified set of KPIs, each KPI of the identified set of KPIs associated with a plurality of KPI attributes used to determine a KPI score associated with each KPI;
identifying, by the recommendation system, a set of particular KPI attributes associated with the identified set of KPIs associated with the particular client as an identified set of particular KPI attributes;
performing, by the recommendation system, a recommendation assessment of the identified set of particular KPI attributes using a trained recommendation reference model (RRM) to identify at least one operational recommendation for the particular client as the identified at least one operational recommendation, the identified at least one operational recommendation associated with at least one KPI of the identified set of KPIs;
generating, by the recommendation system, a ranked set of the identified at least one operational recommendation based on a ranking associated with each KPI of the at least one KPI of the identified set of KPIs; and
providing, by the recommendation system, the ranked set of the identified at least one operational recommendation to the particular client.

2. The computer-implemented method of claim 1, wherein the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client.

3. The computer-implemented method of claim 1, further comprising:
training a RRM to generate the trained RRM using a machine learning algorithm, a set of reference KPI attributes, a set of reference KPIs associated with at least one client, and a set of reference operational recommendations, wherein the set of reference KPIs includes at least the identified set of KPIs, and wherein the set of reference operational recommendations includes at least the at least one operational recommendation.

4. The computer-implemented method of claim 3, wherein training the RRM further comprises using a loss function.

5. The computer-implemented method of claim 3, wherein the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs.

6. The computer-implemented method of claim 3, wherein the machine learning algorithm comprises at least one of a supervised learning algorithm using a deep neural network (DNN).

7. The computer-implemented method of claim 6, wherein the DNN comprises at least one of a convolution neural network or a long short-term memory (LSTM).

8. A non-transitory, computer-readable medium storing one or more instructions executable by a computer system to perform operations comprising:
identifying, by a recommendation system, a set of key performance indicators (KPIs) associated with a particular client of a set of clients as an identified set of KPIs, each KPI of the identified set of KPIs associated with a plurality of KPI attributes used to determine a KPI score associated with each KPI;
identifying, by the recommendation system, a set of particular KPI attributes associated with the identified set of KPIs associated with the particular client as an identified set of particular KPI attributes;
performing, by the recommendation system, a recommendation assessment of the identified set of particular KPI attributes using a trained recommendation reference model (RRM) to identify at least one operational recommendation for the particular client as the identified at least one operational recommendation, the identified at least one operational recommendation associated with at least one KPI of the identified set of KPIs;
generating, by the recommendation system, a ranked set of the identified at least one operational recommendation based on a ranking associated with each KPI of the at least one KPI of the identified set of KPIs; and
providing, by the recommendation system, the ranked set of the identified at least one operational recommendation to the particular client.

9. The non-transitory, computer-readable medium of claim 8, wherein the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client.

10. The non-transitory, computer-readable medium of claim 8, further comprising:
training a RRM to generate the trained RRM using a machine learning algorithm, a set of reference KPI attributes, a set of reference KPIs associated with at least one client, and a set of reference operational recommendations, wherein the set of reference KPIs includes at least the identified set of KPIs, and wherein the set of reference operational recommendations includes at least the at least one operational recommendation.

11. The non-transitory, computer-readable medium of claim 10, wherein training the RRM further comprises using a loss function.

12. The non-transitory, computer-readable medium of claim 10, wherein the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs.

13. The non-transitory, computer-readable medium of claim 10, wherein the machine learning algorithm comprises at least one of a supervised learning algorithm using a deep neural network (DNN).

14. The non-transitory, computer-readable medium of claim 13, wherein the DNN comprises at least one of a convolution neural network or a long short-term memory (LSTM).

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying, by a recommendation system, a set of key performance indicators (KPIs) associated with a particular client of a set of clients as an identified set of KPIs, each KPI of the identified set of KPIs associated with a plurality of KPI attributes used to determine a KPI score associated with each KPI;
identifying, by the recommendation system, a set of particular KPI attributes associated with the identified set of KPIs associated with the particular client as an identified set of particular KPI attributes;
performing, by the recommendation system, a recommendation assessment of the identified set of particular KPI attributes using a trained recommendation reference model (RRM) to identify at least one operational recommendation for the particular client as the identified at least one operational recommendation, the identified at least one operational recommendation associated with at least one KPI of the identified set of KPIs;
generating, by the recommendation system, a ranked set of the identified at least one operational recommendation based on a ranking associated with each KPI of the at least one KPI of the identified set of KPIs; and
providing, by the recommendation system, the ranked set of the identified at least one operational recommendation to the particular client.

16. The computer-implemented system of claim 15, wherein the at least one KPI of the identified set of KPIs associated with the identified at least one operational recommendation performed poorly compared against at least one of a best in class KPI calculated across the set of clients, an average KPI calculated across the set of clients, an industry best in class KPI calculated across the set of clients in the same industry as the particular client, an industry average KPI calculated across the set of clients in the same industry as the particular client, a region best in class KPI calculated across the set of clients in the same region as the particular client, or a region average KPI calculated across the set of clients in the same region as the particular client.

17. The computer-implemented system of claim 15, further comprising:
training a RRM to generate the trained RRM using a machine learning algorithm, a set of reference KPI attributes, a set of reference KPIs associated with at least one client, and a set of reference operational recommendations, wherein the set of reference KPIs includes at least the identified set of KPIs, and wherein the set of reference operational recommendations includes at least the at least one operational recommendation.

18. The computer-implemented system of claim 17, wherein training the RRM further comprises using a loss function.

19. The computer-implemented system of claim 17, wherein the loss function may comprise at least one of a binary logistic loss function that predicts the performance of each reference KPI of the set of KPIs or a multi-level logistic loss function that determines at least one reference operational recommendation of the set of reference operational recommendations to recommend for each reference KPI of the set of reference KPIs.

20. The computer-implemented system of claim 17, wherein the machine learning algorithm comprises at least one of a supervised learning algorithm using a deep neural network (DNN).
